(19) United States
(12) Patent Application Publication
(10) Pub. No.: US 2023/0332734 A1
(43) Pub. Date: Oct. 19, 2023

(54) DEVICE COMPATIBLE MOUNTING STAND

(71) Applicants: Steven Wai-Tong Cheng, Plainview, NY (US); Sergio Portella DeAlbuquerque, Plainview, NY (US)

(72) Inventors: Steven Wai-Tong Cheng, Plainview, NY (US); Sergio Portella DeAlbuquerque, Plainview, NY (US)

(21) Appl. No.: 18/107,468

(22) Filed: Feb. 8, 2023

Related U.S. Application Data
(60) Provisional application No. 63/308,189, filed on Feb. 9, 2022.

(51) Int. Cl. F16M 13/02

(52) U.S. Cl. CPC F16M 13/02

(57) ABSTRACT

An apparatus for securely mounting devices onto a variety of surfaces is disclosed. In some implementations, the apparatus comprises a surface mounting plate and a device mounting plate. In some implementations, the device mounting plate is compliant or compatible with VESA standards. In some implementations, the surface mounting plate and the device mounting plate are assembled together. In some implementations, the surface mounting plate can be secured against unauthorized removal. In some implementations, the surface mounting plate can allow electricity to pass from a connected electric source to the assembled apparatus so as to enable a device mounted on the assembly to receive power, data, and/or other signals. In some of the implementations, the apparatus enables the provision of cordless, wireless, or inductive charging.

### RELATED APPLICATIONS

This application claims the benefit of U.S. Application No. 63/308,189, entitled “VESA-standards compatible bracket, with multi-scenario mounting support and optional low voltage charging,” and filed on Feb. 9, 2022, which is incorporated herein by reference in its entirety.

### TECHNICAL FIELD

Embodiments relate generally to systems for mounting devices, and more particularly, to device compatible mounting assemblies for mounting devices onto different types of surfaces.

### BACKGROUND

Originally, mounting systems compatible with VESA (Video Electronics Standards Association) standards enabled devices such as monitors, televisions, and large display devices to be fixed permanently and securely through VESA ready mounting systems. With the advent of compact personal computers (PC) and tablet-based touch screens, interactive displays, and other touch-feedback digital signage, VESA mounting standards spread to smaller devices and many touch panel, tablet enclosures, and other such devices now enable VESA compatible mounting.

VESA compatible or VESA ready display solutions may be powered using low voltage wiring, such as but not limited to CATS networking cable, which can carry both power and data. Such low voltage powering setups may require a type of adapter or dongle that can transform a single low-voltage line into a line that can transmit both power and data. However, concealing these wires within such VESA ready or VESA compatible display solutions is a challenge.

Designs in the prior art, such as those shown in U.S. Pat. Nos. 7,513,474B2, 8,919,716B2, 9,010,699B2, US20130126685A1, and US20170003712A1 generally assume that the VESA ready or VESA compatible devices that need to be mounted do not need integrated power or connectivity. Such designs offer no support for hidden cable or wire-management for VESA ready or VESA compatible devices, thereby rendering them inappropriate for the vast majority of display setups that require wires/cables to be hidden for better aesthetics and a clean/neat look.

Designs in the prior art may generally not allow rapid connection and disconnection of power to VESA compatible or VESA ready devices. This constraint stems from the requirement of a semi-permanently connected charging wire to provide power to the VESA ready mounted device. With the advent of newer, rapidly disconnect-able charging technologies, such as those shown in U.S. patent Ser. No. 10/938,147, there exists a need for enabling rapid connection/disconnection.

Setups based on above discussed and similar prior art designs may lead to wiring being exposed as there may not be provisions, such as empty spaces or empty slots, to accommodate auxiliary power supply cables or external power packs so as to hide them neatly/aesthetically. This constraint may also increase setup time and/or labor costs if the setup is in a semi-public or public space, where exposed wiring may subject the setup to vandalism or unwanted damage. If a power pack is used, such designs may cause the power pack to be left out, fully visible and out in the open, and subject the setup to a messy look or possibly unintended removal, e.g., theft.

Furthermore, in cases where multiple mounts are required with different mounting requirements, e.g., on-wall, on-cinder block, on-glass installations, users may need to purchase different mounting brackets for each mounting surface. Otherwise, users would be strictly limited to the mounting options supported by the purchased hardware. Also, if changes need to be made after the setup's initial design stage or after the purchase is finalized, e.g., last minute changes, the lack of flexibility during installation may result in difficulties, especially if security requirements change. Designs shown in the prior art, such as the ones shown in U.S. Pat. Nos. 7,513,474B2, 8,919,716B2, 9,010,699B2, US20130126685A1, US20170003712A1 may not provide the flexibility of mounting a device in various scenarios or on different surfaces, beyond very obvious changes to the type of fastening hardware used, thus limiting their use or applicability.

Therefore, designs shown in the prior art may not always result in the desired or optimal setup. More specifically, in some scenarios, the mounted device may have exposed wiring, and/or it may not be secured against theft or unauthorized removal, and/or it may not be rapidly disconnect-able and/or disassemble-able due to the power charging cable being separately connected to the device. Furthermore, custom wiring may be required to integrate power, data, and other connectivity options, resulting in increased cost of setup. For setups with no nearby power that need an auxiliary power source, power packs may be left exposed, out in the open, with exposed wiring, potentially exposing the setup to theft and/or unauthorized removal. The above challenges may result in setups that cannot be easily secured and/or easily charged, and/or setups that have a clean, aesthetic look, and/or setups that suffer from a much higher overall cost of installation. Hence, there is a need for solutions that address the aforementioned limitations.

Some implementations were conceived in light of the above-mentioned needs, problems and/or limitations, among other things.

### SUMMARY

Some implementations can include an apparatus for mounting an electronic device, where the apparatus includes a device mounting plate configured for the electronic device to be mounted onto the device mounting plate. In some implementations, the device mounting plate comprises one or more device holes. The apparatus can also include a surface mounting plate. In some implementations, the surface mounting plate comprises one or more surface holes, wherein the one or more device holes align with the one or more surface holes.

In some implementations, the surface mounting plate is configured to be mounted onto a surface, and wherein the device mounting plate and the surface mounting plate are configured to be assembled together by fastening the device mounting plate to the surface mounting plate through one or more of a mechanical fastening mechanism or a non-mechanical fastening mechanism.

In some implementations, the surface mounting plate is mounted onto a wall surface using one or more of one or more screws or one or more anchors. In some implementations, the surface mounting plate is mounted onto a glass surface using one or more of one or more suction cups with one or more optional self-tapping screws, or with non-mechanical methods such as, but not limited to, double-sided adhesive, adhesive-backed hook and loop fastener, epoxy, or other chemical bonding agents.

In some implementations, the surface mounting plate comprises a multi-pin connector, wherein the multi-pin connector is configured to interface with one or more of one or more pogo pins, one or more spring-loaded pins, or one or more fixed contact points. In some implementations, one or more of the one or more pogo pins, the one or more spring-loaded pins, or the one or more fixed contact points are configured to connect to an RJ45 connector.

In some implementations, the device mounting plate comprises one or more of a centered through hole or a radial clearance channel. In some implementations, the device mounting plate comprises one or more VESA compatible hole patterns configured to interface with VESA compatible devices.

In some implementations, the surface mounting plate comprises one or more surface mounting plate apertures, wherein the one or more surface mounting plate apertures are compatible with one or more gangbox apertures of one or more gangboxes. In some implementations, the mechanical fastening mechanism involves affixing one or more fasteners through the one or more device holes and the corresponding one or more surface holes.

In some implementations, the device mounting plate comprises one or more of one or more pogo pins, one or more spring-loaded pins, or one or more fixed contact points. In some implementations, the device mounting plate comprises a hole at a center of the device mounting plate, and wherein a spiral metal coil is wound around the hole for inductive charging and/or data passthrough for the mounted device. In some implementations, the device mounting plate comprises a Kensington lock slot.

Some implementations can include an apparatus for mounting an electronic device. The apparatus can include a device mounting plate configured for the electronic device to be mounted onto the device mounting plate, and a surface mounting plate. In some implementations, the surface mounting plate is configured to be mounted onto a surface, and the device mounting plate and the surface mounting plate are assembled together by fastening the device mounting plate to the surface mounting plate through one or more of a mechanical fastening mechanism or a non-mechanical fastening mechanism. The apparatus can also include one or more spacers between one or more of the electronic device and the device mounting plate or between the surface mounting plate and the surface configured to provide access to one or more of a rear side of the electronic device or the surface.

In some implementations, the device mounting plate is designed to create a predetermined amount of void space between the device mounting plate and the surface mounting plate when the device mounting plate and the surface mounting plate are assembled together. In some implementations, the non-mechanical fastening mechanism involves use of one or more of chemical bonding agents, epoxies, or welding. In some implementations, the device mounting plate comprises a Kensington lock slot.

Some implementations can include an apparatus for mounting an electronic device. The apparatus can include a device mounting plate configured for the electronic device to be mounted onto the device mounting plate. In some implementations, the device mounting plate comprises one or more device flanges. The apparatus can also include a surface mounting plate.

In some implementations, the surface mounting plate comprises one or more surface flanges, and wherein the surface mounting plate is configured to be mounted onto a surface. In some implementations, the device mounting plate and the surface mounting plate are assembled together through one or more of the one or more device flanges interlocking with one or more of the one or more surface flanges using one or more flanges located on each of the surface mounting plate and the device mounting plate.

In some implementations, the device mounting plate and the surface mounting plate are secured through one or more screws. In some implementations, the device mounting plate is designed to create a predetermined amount of void space between the device mounting plate and the surface mounting plate when the device mounting plate and the surface mounting plate are assembled together. In some implementations, the device mounting plate comprises a Kensington lock slot.

### BRIEF DESCRIPTION OF THE DRAWINGS

FIG. 1 is an exploded view of an unassembled example mounting assembly in accordance with some implementations.

FIGS. 2A and 2B shows perspective views of an example surface mounting plate and example gang boxes in accordance with some implementations.

FIG. 3 is a perspective view of an example surface mounting plate being installed onto an example drywall in accordance with some implementations.

FIG. 4 is a perspective view of an example surface mounting plate being installed onto an example glass surface in accordance with some implementations.

FIG. 5 is a perspective view of an example surface mounting plate being installed onto an example Decora-style outlet in accordance with some implementations.

FIG. 6 is a front view of an example surface mounting plate in accordance with some implementations.

FIG. 7 is a front view of an example device mounting plate in accordance with some implementations.

FIG. 8 is a front view of an example device mounting plate in accordance with some implementations.

FIGS. 9A, 9B, and 9C shows perspective views of an example surface mounting plate and an example device mounting plate being assembled together in accordance with some implementations.

FIGS. 10A and 10B show a perspective view of a device mounting plate being affixed to a surface mounting plate and a side view of an assembled device mounting plate and surface mounting plate combination in accordance with some implementations.

FIG. 11 shows a perspective view of a device mounting plate including a Kensington Slot in accordance with some implementations.

FIG. 12 is a side view of an example installation of an example mounted device on an example surface through an assembly comprising an example assembly of an example surface mounting plate and example device mounting plate in accordance with some implementations.

FIG. 13 is a side view of an example installation of an example mounted device on an example surface through an assembly comprising an example assembly of an example surface mounting plate and example device mounting plate in accordance with some implementations.

FIG. 14 is a side view of an example installation of an example mounted device on an example surface through an assembly comprising an example assembly of an example surface mounting plate and example device mounting plate in accordance with some implementations.

### DETAILED DESCRIPTION

Those of ordinary skill in the art will realize that the following detailed description of the present invention is illustrative and is not intended to be limiting in any way. Other embodiments of this invention will be apparent to those skilled in the art having the benefit of this disclosure.

The term “VESA” hereinafter refers to the VESA Mounting Interface Standard, also known as the VESA Mount, which is a family of standards defined by the Video Electronics Standards Association for mounting flat panel monitors, televisions (TVs), and other displays to floor stands and/or wall mounts. It can be implemented on devices such as, but not limited to, modern flat-panel monitors, TVs, as well as some specialized tablets designed for mounting.

The term “Kensington Slot” hereinafter refers to a Kensington Security Slot, which is part of an anti-theft system designed and patented by Kryptonite in 1999-2000 through U.S. Pat. Nos. 6,081,974, 6,317,936, and 6,360,405, in which a Kensington lock can be installed.

This disclosure pertains to an apparatus that allows a VESA-ready device to be installed at a fixed location, with a fixed or adjustable angle for easy viewing. The apparatus may be designed as two or more pieces that can be combined into a single assembly. The pieces may comprise a wall plate that is permanently affixed to a surface and a VESA plate that is affixed to a VESA-ready device. The plates can be assembled together and optionally secured against disassembly via fasteners or through non-mechanical means. Also, the assembly may be designed to provide optional cable management and/or power charging functionalities, Ethernet data pass-thru, audio/video data pass-thru, and/or other electronic signal pass-thru functionalities.

A growing number of displays, including flat-panel monitors, TVs, specialized tablets, and tablet enclosures, are becoming smaller and facilitating more interaction with users. Such devices may need to be installed or placed onto a surface for display to or interaction with users.

Prior art designs shown in US20160215926A1 and U.S. Pat. No. 9,128,668B2 enable a tablet computer to be directly mounted onto a wall or a gang box (US20160215926A1) or onto smooth surfaces for display (U.S. Pat. No. 9,128,668B2) respectively. However, these prior art designs use proprietary casings that may not enable non-tablet or standard VESA-ready devices to be mounted. Also, such designs include connected charging cables and thus may not allow rapid assembly or disassembly of the installation. On the other hand, the present disclosure enables standard VESA-ready devices to be readily mounted onto a variety of surfaces. The present disclosure also enables rapid assembly or disassembly of such devices from a mounted surface.

Some implementations comprise an apparatus that includes a surface mounting plate that can be fixed onto a variety of surfaces. In some implementations, the surface mounting plate may have a variety of mounting in-built holes for compatibility with a mounting to, but not limited to, a US, an EU, or an international electrical gangbox, a single, a double, a triple, or other variant of a gangbox or an electric enclosure. In some implementations of the mounting holes, a rectangular hole matching a standard Decora style wall outlet can be built into the design. This enables the surface mounting plate to act as a substitute for a standard receptacle wall plate while allowing a preinstalled Decora-style outlet to fit into the rectangular hole matching the above wall outlet.

In some implementations, the surface mounting plate can have two or more additional pre-fabricated holes to allow for the installation of suction cups made of elastomeric or similar materials to be installed. In some implementations, these suction cups can be secured onto the mount by installing a self-tapping screw into the protrusion side so as to expand the suction cup and make the protrusion larger than the hole, thus preventing it from disassembly. An installation in this configuration enables the assembly to be mounted onto any glass or other such surface. In some implementations, the fastening method used to secure suction cups to the surface mounting plate may be a non-mechanical method. In some implementations, the non-mechanical method involves use of chemical bonding agents, epoxies, welding, or other manufacturing methods.

In some implementations, additional parts can be fixed to one or more holes through additional flanges so as to secure and affix the above additional parts onto the assemblage.

In some implementations, the fastening method used to secure the VESA mounting plate to the surface mounting plate may be a non-mechanical method. In some implementations, the non-mechanical method involves use of chemical bonding agents, epoxies, welding, or other manufacturing methods. In some implementations, the VESA mounting plate may be made, assembled, or integrated with one or more pogo or spring-loaded pins or fixed contact points as an interface for transferring electric power, data, and/or other signals from the surface mounting plate through the VESA mounting plate to the device mounted onto the VESA mounting plate. In some implementations, the VESA mounting plate may be made, assembled, or integrated with proprietary magnetic surface contacts, such as, but not limited to, technologies specified in U.S. Pat. No. 10,938,147 to enable transfer of electric power, data, and/or other signals from the surface mounting plate via the VESA mounting plate to devices mounted onto the VESA mounting plate.

In some implementations, some or all of the pogo or spring-loaded pins or fixed contact points may interface with an integrated metal coil built into the VESA mounting plate so as to create a magnetic field when current passes through. The magnetic field may support wireless charging for compatible devices when mounted onto an assembly with the above design. In some implementations, some or all of the pogo or spring-loaded pins or fixed contact points may be connected to inductive charging electronics and/or coils to enable cordless charging. In some implementations, such inductive charging electronics can be assembled, embedded, and/or affixed onto the surface mounting plate instead of or in lieu of the VESA mounting plate.

In some implementations, the VESA mounting plate and/or the surface mounting plate can be manufactured with dimensions that creates an optional void space between the inside surfaces of the surface mounting plate and the VESA mounting plate. In some implementations, this void space can be used for storage of additional components, such as but not limited to Ethernet adapters, power converters, power storage banks, and/or other data connectivity hardware as needed by the VESA compatible device mounted onto the VESA mounting plate.

In some implementations, on one of the edges, surfaces, or additional protrusions on the VESA mounting plate, a Kensington Slot may be built-in to enable the VESA mounting plate to be removable by securing the VESA mounting plate via a Kensington lock with attached tether.

In some implementations, spacers can be installed between the back of a VESA mounting plate and a VESA-ready device and/or between the surface mounting plate and the surface on which the surface mounting plate is to be mounted on. This creates additional spacing between the VESA-ready device and the surface onto which it is to be mounted. This arrangement may be useful for setups where additional void space is needed for optional peripherals or connectors that require quick and easy access. This may be particularly useful when the connecting input and/or output ports are not required to be covered, shielded, and/or secured against tampering.

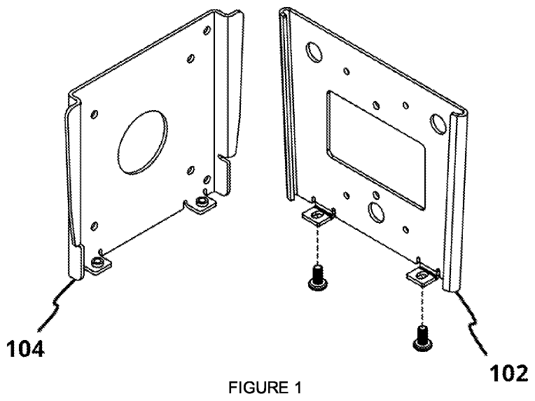

FIG. 1 is an exploded view of an unassembled example mounting assembly in accordance with some implementations. FIG. 1 shows a Surface Mounting Plate (102) and a Device Mounting Plate (104) of an example mounting assembly in an exploded unassembled view.

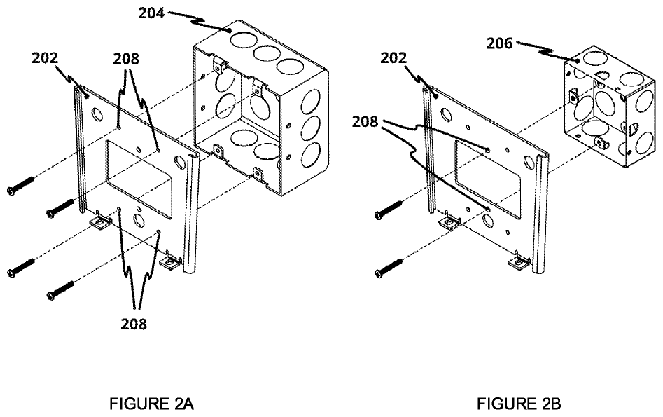

FIGS. 2A and 2B show perspective views of an example surface mounting plate and example gangboxes in accordance with some implementations. FIGS. 2A/2B show a Surface Mounting Plate's (202) compatibility to be mounted onto US gangboxes (204) as well as EU gang boxes (206) owing to the built-in holes (208) made in the Surface Mounting Plate (202) to match the apertures in the respective gangboxes. In some implementations, compatibility with other types of gangboxes can be incorporated into a surface mounting plate by including one or more holes to match other gangbox designs, e.g., in-wall boxes, colloquially known also as “China Boxes”.

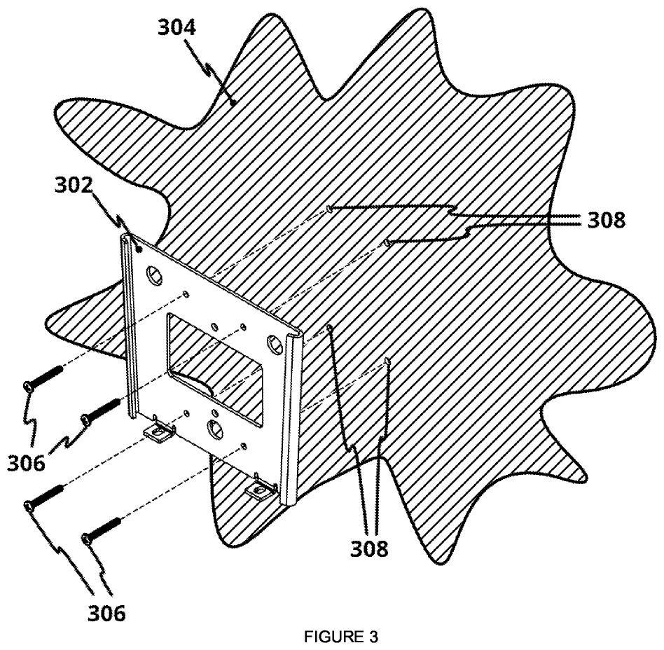

FIG. 3 is a perspective view of an example surface mounting plate being installed onto an example drywall in accordance with some implementations. FIG. 3 illustrates the mounting of a Surface Mounting Plate (302) onto a drywall (304) through a set of screws (306) and a set of anchors (308) affixed to the drywall (304). In some implementations, the Surface Mounting Plate (302) can be mounted onto masonry or any other flat wall surface using the set of screws (306) and the set of anchors (308) displayed in FIG. 3.

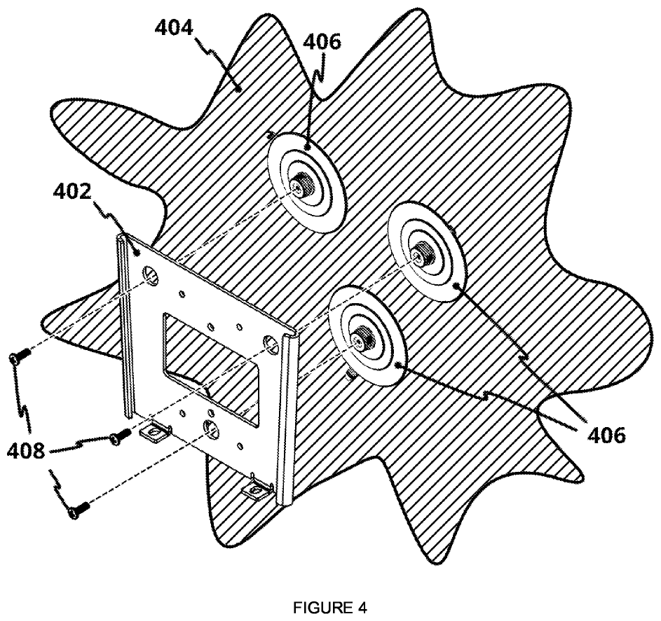

FIG. 4 is a perspective view of an example surface mounting plate being installed onto an example glass surface in accordance with some implementations. FIG. 4 illustrates the mounting of a Surface Mounting Plate (402) onto a glass surface (404) by securing a set of suction cups (406) to the Surface Mounting Plate (402) through a set of self-tapping screws (408). In some implementations, the self-tapping screws (408) can be designed to expand the stems of suction cups to prevent the removal of the suction cups.

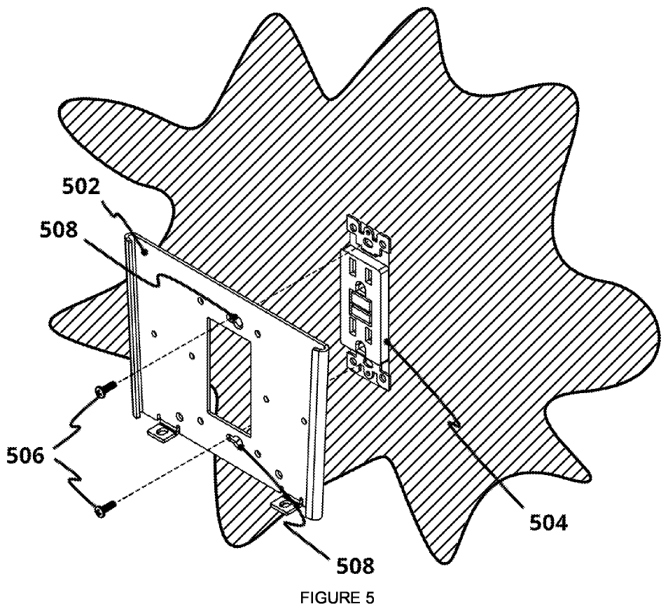

FIG. 5 is a perspective view of an example surface mounting plate being installed onto an example Decora-style outlet in accordance with some implementations. FIG. 5 illustrates the mounting of a Surface Mounting Plate (502) with an alternative hole pattern (508) onto a Decora-style outlet (504) through a set of screws (506). The alternative hole pattern (508) enables the Surface Mounting Plate (502) to be directly mounted onto the Decora-style outlet (504) and the alternative hole pattern (508) obviates the need for a standard gangbox face plate.

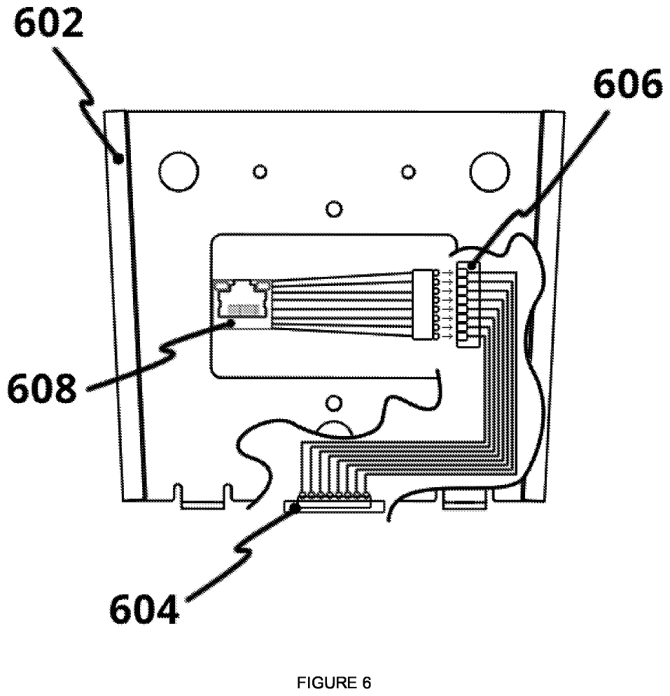

FIG. 6 is a front view of an example surface mounting plate in accordance with some implementations. FIG. 6 displays a Surface Mounting Plate (602) including an optional multi-pin connector (604) that can interface with a set of pogo or spring-loaded pins or fixed contact points (606) for transferring electric power, data, or other signals from an RJ45 connector (608) to a device mounting plate of the mounting assembly apparatus. The multi-pin connector may be a proprietary connector, such as the Apple MagSafe® connector shown in U.S. Pat. No. 10,938,147.

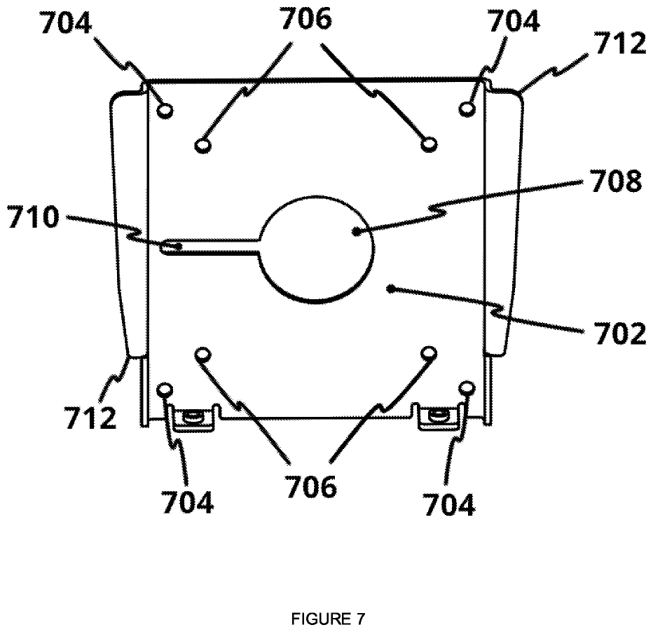

FIG. 7 is a front view of an example device mounting plate in accordance with some implementations. FIG. 7 displays a Device Mounting Plate (702) with VESA 100×100 (704) and VESA 75×75 (706) hole patterns built into the Device Mounting Plate (702) along with an optional centered through hole (708) and an optional radial clearance channel (710) to enable a mounted device's cable(s) and/or wire(s) to pass through the Device Mounting Plate (702). FIG. 7 also shows flanges (712) on the Device Mounting Plate (702) that interlock with a surface mounting plate to secure the surface mounting plate vis-à-vis the Device Mounting Plate (702).

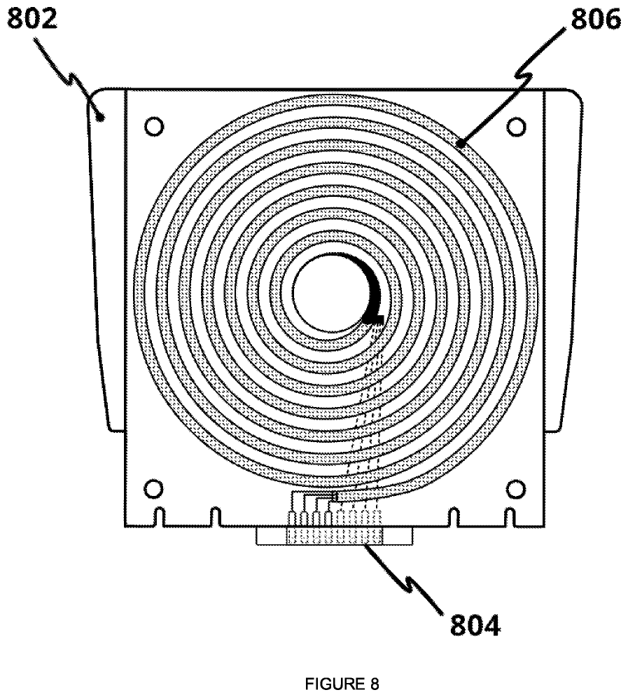

FIG. 8 is a front view of an example device mounting plate in accordance with some implementations. FIG. 8 displays a Device Mounting Plate (802) with one or more sets of pogo or spring-loaded pins or fixed contact points (804) acting as an interface for transferring electric power, data, or other signals. This interface transmits electricity to a spiral metal coil (806) wound about a center hole and built into, added on, or integrated into the Device Mounting Plate.

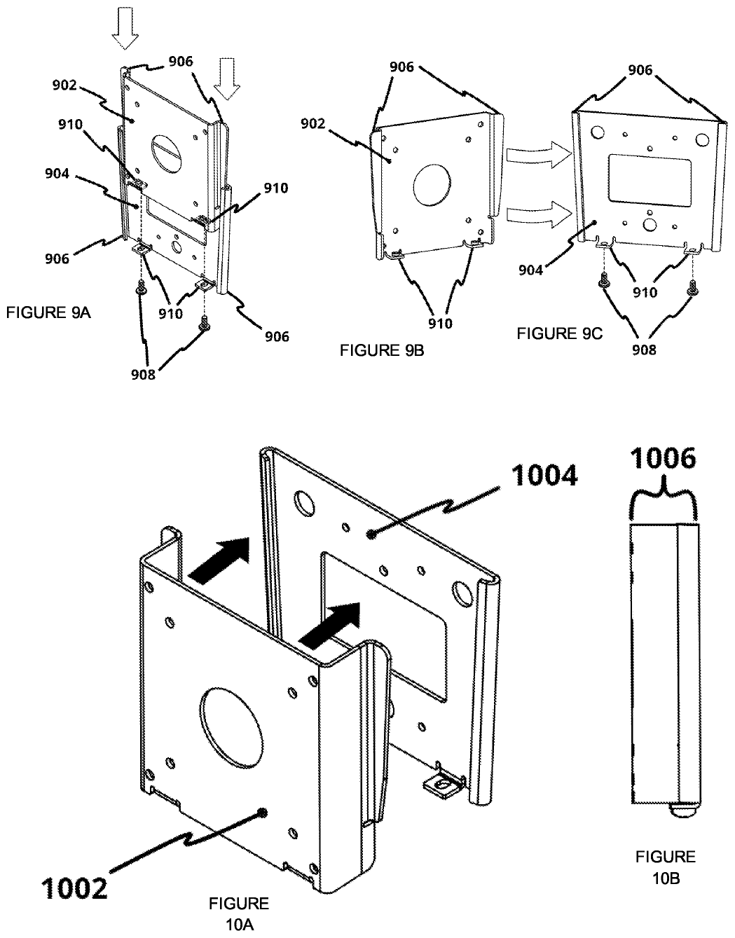

FIGS. 9A-9C show perspective views of an example surface mounting plate and an example device mounting plate being assembled together in accordance with some implementations. FIGS. 9A-9C show how a Surface Mounting Plate (902) and a Device Mounting Plate (904) are assembled together. In some implementations, the surface and device mounting plates can be assembled together by sliding the plates together along matching interlocking flanges (906) on the plates. To prevent unauthorized dissembling/removal of the surface and device mounting plates, screws (908) can be affixed through another set of matching flanges (910) located on the plates.

FIG. 10A shows a perspective view of a device mounting plate being affixed to a surface mounting plate. FIG. 10B shows a side view of an assembled device mounting plate and surface mounting plate combination in accordance with some implementations. FIG. 10A illustrates a Device Mounting Plate (1002) and a surface mounting plate (1004) that is designed with a thickness sufficient to accommodate additional void space (1006) between the mounted Device Mounting Plate (1002) and the surface mounting plate behind it. In some implementations, the additional void space (1006) can accommodate wiring and/or cabling for connecting one or more peripherals to a mounted device, for example.

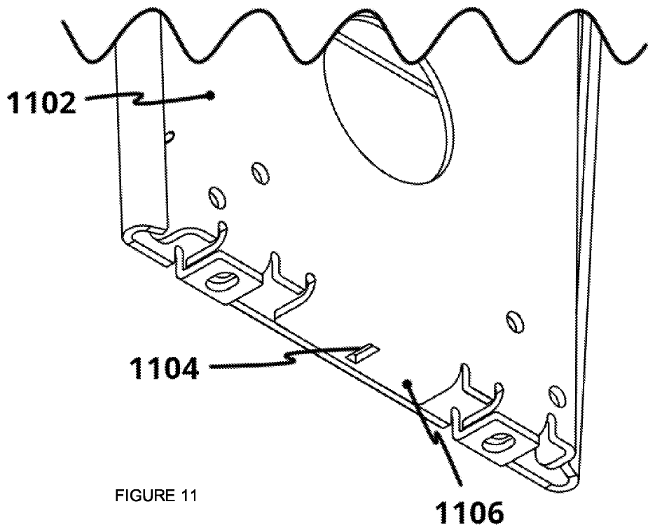

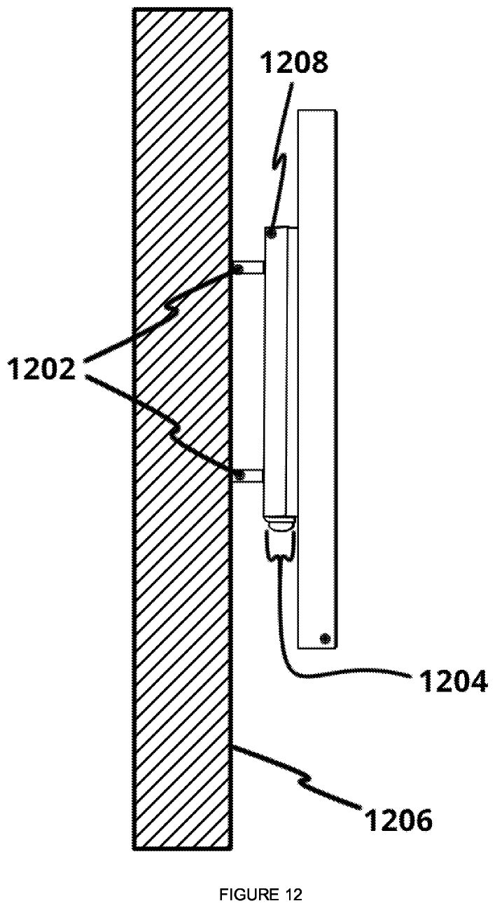

FIG. 11 shows a perspective view of a device mounting plate including a Kensington Slot in accordance with some implementations. FIG. 11 shows a Device Mounting Plate (1102) that includes a Kensington Lock Slot (1104). In some implementations, the Kensington Lock Slot (1104) is attached to the Device Mounting Plate (1102) by means of an additional flange (1106).

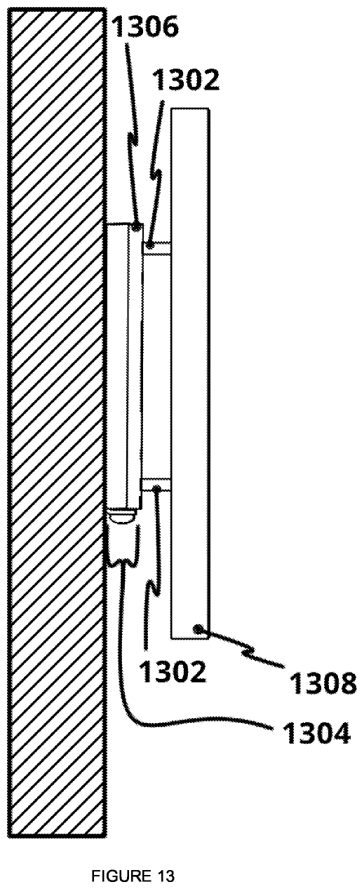

FIG. 12 is a side view of an example installation of an example mounted device on an example surface through an assembly comprising an example assembly of an example surface mounting plate and example device mounting plate in accordance with some implementations.

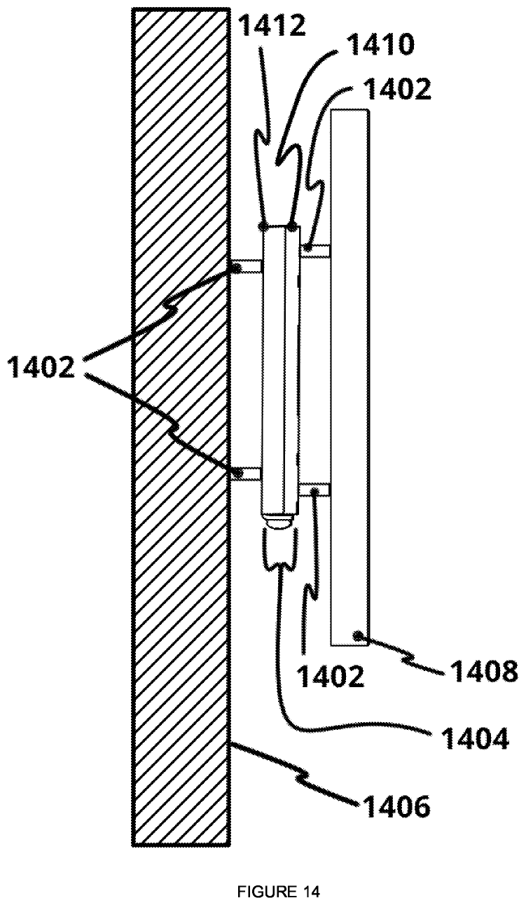

FIG. 13 is a side view of an example installation of an example mounted device on an example surface through an assembly comprising an example assembly of an example surface mounting plate and example device mounting plate in accordance with some implementations.

FIG. 14 is a side view of an example installation of an example mounted device on an example surface through an assembly comprising an example assembly of an example surface mounting plate and example device mounting plate in accordance with some implementations.

FIGS. 12, 13, and 14 show installation scenarios where additional void space is provided between the mounted device and the mounting surface by adding spacers. In FIG. 12, spacers (1202) are added between the mounting assembly (1204) and the mounting surface (1206), more specifically, between the surface mounting plate (1208) and the mounting surface (1206). In FIG. 13, spacers (1302) are added between the mounting assembly (1304) and the mounted device (1308), more specifically, between the device mounting plate (1306) and the mounted device (1308). In FIG. 14, spacers (1402) are added between the mounting assembly (1404) and the mounting surface (1406) as well as the mounting assembly (1404) and the mounted device (1408), more specifically between the device mounting plate (1410) and the mounted device (1408) as well as between the surface mounting plate (1412) and the mounting surface (1406).

FIGS. 1 through 14 demonstrate some of the possible form factors or sizes that the disclosed invention can be in. In these variants, the invention can be directly bolted and/or securely mounted onto any flat surface. Alternatively, suction cups can be used to temporarily install the invention. A Kensington Slot can optionally be added to provide a limited degree of freedom for the mounted device to be moved while preventing unauthorized removal of the device. The invention is equipped to be installed using different mounting options for additional functionality and the descriptions and figured shown herein simply show some examples of possible configurations and should not be construed as a limit on potential embodiments.

It is contemplated that any optional feature of the inventive variations described may be set forth and claimed independently or in combination with any one or more of the features described herein. Reference to a singular item includes the possibility that there is a plurality of the same items present. More specifically, as used herein and in the appended claims, the singular forms “a,” “an,” “said,” and “the” include plural referents unless specifically stated otherwise. In other words, use of the articles allow for “at least one” of the subject item in the description above as well as the claims below. It is further noted that the claims may be drafted to exclude any optional element. As such, this statement is intended to serve as antecedent basis for use of such exclusive terminology as “solely,” “only”, and the like in connection with the recitation of claim elements, or for the use of a “negative” limitation. In the absence of the use of any such exclusive terminology, the term “comprising” in the claims shall allow for the inclusion of any additional element irrespective of whether a given number of elements are enumerated in the claim. Also, the addition of a feature could be regarded as transforming the nature of an element set forth in the claims. Except as specifically defined herein, all technical and scientific terms used herein are to be given as broad a commonly understood meaning as possible while maintaining the validity of below claims.

The breadth of the present invention is not to be limited to the examples provided and/or the subject specification, but rather only by the scope of the claim language. Use of the term “invention” herein is not intended to limit the scope of the claims in any manner. Rather it should be recognized that the “invention” includes the many variations explicitly or implicitly described herein, including those variations that would be obvious to one of ordinary skill in the art upon reading the present specification. Further, it is not intended that any section of this specification (e.g., the Summary, Detailed Description, Abstract, Field of the Invention, etc.) be accorded special significance in describing the invention relative to each other or the claims. All references cited are incorporated by reference in their entirety. Although the foregoing invention has been described in detail for the purpose of clarity of understanding the invention, it is contemplated that certain modifications to the invention may be practiced within the scope of the claims below.

It is, therefore, apparent that there is provided, in accordance with the various embodiments disclosed herein, systems for mounting devices onto surfaces, including device compatible bracket assemblies for mounting devices onto different types of surfaces.

While the disclosed subject matter has been described in conjunction with a number of embodiments, it is evident that many alternatives, modifications, and variations would be, or are, apparent to those of ordinary skill in the applicable arts. Accordingly, the Applicant intends to embrace all such alternatives, modifications, equivalents, and variations that are within the spirit and scope of the disclosed subject matter.

What is claimed is:

1. An apparatus for mounting an electronic device comprising:
a device mounting plate configured for the electronic device to be mounted onto the device mounting plate, wherein the device mounting plate comprises one or more device holes; and
a surface mounting plate, wherein the surface mounting plate comprises one or more surface holes, wherein the one or more device holes align with the one or more surface holes, wherein the surface mounting plate is configured to be mounted onto a surface, and wherein the device mounting plate and the surface mounting plate are configured to be assembled together by fastening the device mounting plate to the surface mounting plate through one or more of a mechanical fastening mechanism or a non-mechanical fastening mechanism.

2. The apparatus of claim 1, wherein the surface mounting plate is mounted onto a wall surface using one or more of one or more screws or one or more anchors.

3. The apparatus of claim 1, wherein the surface mounting plate is mounted onto a glass surface using one or more of one or more suction cups and one or more self-tapping screws.

4. The apparatus of claim 1, wherein the surface mounting plate comprises a multi-pin connector, wherein the multi-pin connector is configured to interface with one or more of one or more pogo pins, one or more spring-loaded pins, or one or more fixed contact points.

5. The apparatus of claim 4, wherein one or more of the one or more pogo pins, the one or more spring-loaded pins, or the one or more fixed contact points are configured to connect to an RJ45 connector.

6. The apparatus of claim 1, wherein the device mounting plate comprises one or more of a centered through hole or a radial clearance channel.

7. The apparatus of claim 1, wherein the device mounting plate comprises one or more VESA compatible hole patterns configured to interface with VESA compatible devices.

8. The apparatus of claim 1, wherein the surface mounting plate comprises one or more surface mounting plate apertures, wherein the one or more surface mounting plate apertures are compatible with one or more gangbox apertures of one or more gangboxes.

9. The apparatus of claim 1, wherein the mechanical fastening mechanism involves affixing one or more fasteners through the one or more device holes and the corresponding one or more surface holes.

10. The apparatus of claim 1, wherein the device mounting plate comprises one or more of one or more pogo pins, one or more spring-loaded pins, or one or more fixed contact points.

11. The apparatus of claim 1, wherein the device mounting plate comprises a hole at a center of the device mounting plate, and wherein a spiral metal coil is wound around the hole.

12. The apparatus of claim 1, wherein the device mounting plate comprises a Kensington lock slot.

13. An apparatus for mounting an electronic device comprising:
a device mounting plate configured for the electronic device to be mounted onto the device mounting plate;
a surface mounting plate, wherein the surface mounting plate is configured to be mounted onto a surface, and wherein the device mounting plate and the surface mounting plate are assembled together by fastening the device mounting plate to the surface mounting plate through one or more of a mechanical fastening mechanism or a non-mechanical fastening mechanism; and
one or more spacers between one or more of the electronic device and the device mounting plate or between the surface mounting plate and the surface configured to provide access to one or more of a rear side of the electronic device or the surface.

14. The apparatus of claim 13, wherein the device mounting plate is designed to create a predetermined amount of void space between the device mounting plate and the surface mounting plate when the device mounting plate and the surface mounting plate are assembled together.

15. The apparatus of claim 13, wherein the non-mechanical fastening mechanism involves use of one or more of chemical bonding agents, epoxies, or welding.

16. The apparatus of claim 13, wherein the device mounting plate comprises a Kensington lock slot.

17. An apparatus for mounting an electronic device comprising:
a device mounting plate configured for the electronic device to be mounted onto the device mounting plate, wherein the device mounting plate comprises one or more device flanges; and
a surface mounting plate, wherein the surface mounting plate comprises one or more surface flanges, and wherein the surface mounting plate is configured to be mounted onto a surface, and wherein the device mounting plate and the surface mounting plate are assembled together through one or more of the one or more device flanges interlocking with one or more of the one or more surface flanges using one or more flanges located on each of the surface mounting plate and the device mounting plate.

18. The apparatus of claim 17, wherein the device mounting plate and the surface mounting plate are secured through one or more screws.

19. The apparatus of claim 17, wherein the device mounting plate is designed to create a predetermined amount of void space between the device mounting plate and the surface mounting plate when the device mounting plate and the surface mounting plate are assembled together.

20. The apparatus of claim 17, wherein the device mounting plate comprises a Kensington lock slot.
